(19) United States
(12) Patent Application Publication
(10) Pub. No.: US 2004/0184039 A1
(43) Pub. Date: Sep. 23, 2004

(54) Co-ordinate measuring device with additional heat source

(76) Inventor: Ralf Christoph, Giessen (DE)

Correspondence Address: DENNISON, SCHULTZ, DOUGHERTY & MACDONALD, 1727 KING STREET, SUITE 105, ALEXANDRIA, VA, 22314, US

(21) Appl. No.: 10/483,049

(22) PCT Filed: Jul. 5, 2002
(86) PCT No.: PCT/EP02/07469

(30) Foreign Application Priority Data
Jul. 16, 2001 (DE) 101 33 824.4

(51) Int. Cl. G01B 11/24

(52) U.S. Cl. 356/601; 33/503

(57) ABSTRACT

A co-ordinate measuring device with at least one heat-emitting element arranged thereon and/or therein, such as a motor or light source. According to the invention, in order to exclude temperature-dependant measurement inaccuracies, an additional heat supply is provided for the heat-emitting element such that the total power which affects the coordinate measuring device remains substantially constant.

The invention concerns a coordinate measuring device with at least one allocated and/or integrated heat-emitting element such as an engine or a light source. In addition, the invention refers to an operational process of a coordinate measuring device with an allocated and/or integrated heat-emitting element such as an engine or a light source.

In order to measure objects with high precision using a coordinate measuring system, it is necessary that there be no measurement corruptions caused by changing temperatures. It is suggested in DE 38 23 373 A1 that a coordinate measuring scanner be optionally exchanged with a temperature sensor in order to determine the temperature of the object to be measured. An alternative option is to measure the temperature using a contact free method.

Another suggestion according to the state of the art proposes to use thermally insulated plane tables in coordinate measuring devices in order to exclude the influence of temperature fluctuations (see DE.Z. Coordinate Measuring Devices by Carl Zeiss. Prismo. Der Maβstab, page 13).

Even if one can ascertain and compensate for temperature fluctuations of the object to be measured in accordance with the first suggestion, the occurrence of deformations that influence the measurement values, based on different temperatures for example at the edges of the suspensions or temperature changes in the suspensions, still is not excluded. The use of thermally insulated plane tables leads to a significant increase in prices of the coordinate measuring device. Independently, deformations at the bracket caused by the temperature of the thermally insulated plate tables can again lead to measurement corruptions.

It is the goal of the present invention to further develop a coordinate measuring device and a process of the above-mentioned type such that the measurement deviations or corruptions caused by temperature fluctuations are omitted, without requiring that the temperature of the object be determined.

The problem is essentially solved according to the invention with a coordinate measuring device of the type described above, such that a supplementary heat source is added to the element that emits heat in such a way that the total load influencing the coordinate measuring device is constant or almost constant. A heat resistor in particular is used as the supplementary heat source.

In particular the invention provides that an adjustable heat resistor is allocated to each element that emits heat, such that the load P₁ of the heat-emitting element and the load P₂ of the adjustable heat resistor is P₁+P₂=constant or P₁+P₂≈constant. Several heat-emitting elements can be allocated to a common adjustable heat resistor. Of course, a separately adjustable heat resistor can also be allocated to each heat-emitting element.

Heat-emitting elements that are heat sources based on the operation, for example engines and actuators or light sources, and supplementary heat sources are spatially allocated relative to one another in such a way that the load that acts upon the coordinate measuring device is constant or almost constant, so that as a result the coordinate measuring device shows a constant temperature, thus measurement corruptions are excluded.

The fundamental idea of the invention consequently provides that technically dependent sources of heat such as light sources or engines that are absolutely necessary in coordinate measuring devices do not also lead to temperature changes in the coordinate measuring devices or in their temperature environment if the heat sources are operated with various loads or if they are switched off, for example. If, for example, a light source is throttled, then the supplementary heat source, such as a heat resistor, is adjusted in order to secure unchanged temperature conditions. If a light source is throttled the load of the heat resistor is increased, and vice versa. In an engine the power emitted from it and from the supplementary heat source can, for example, be adjusted to the maximum load of the engine. As the actual load lies below the maximum load, the heat resistor is adjusted in such a way that the heat emitted from the heat resistor and from the engine is constant.

Based upon the teaching of the invention no calculated compensation of the temperature changes takes place. In fact, the coordinate measuring device is used in an environment in which a constant temperature prevails, independent of the heat-emitting elements such as the components of the coordinate measuring device. The result therefore is a thermally stable coordinate measuring device.

A process for operating a coordinate measuring device with at least one heat-emitting element that is allocated to it and/or integrated, such as an engine or a light source, is characterized by the fact that a supplementary heat source is allocated to the heat-emitting element in such a way that the total load acting upon the coordinate measuring device is constant or nearly constant when the coordinate measuring device is operated.

It is provided in particular that the load P₁ accepted or emitted from the heat-emitting element is measured and the supplementary heat source is operated at a load P₂, wherein P₁+P₂=constant or P₁+P₂≈constant.

Via the measured load P₁ a heat resistor as a supplementary heat source can be adjusted to the load P₂ in such a way that P₁+P₂=constant or P₁+P₂≈constant.

In particular, a supplementary heat source is allocated to the heat-emitting element in such a way that, independent of the load accepted or emitted by the heat-emitting element, the coordinate measuring device is operated in a constant temperature environment.

Additional details, advantages and characteristics of the invention result not only from the claims and from their characteristics—independently and in combination—but also from the following description of the drawings with their preferred exemplary embodiments.

These show:

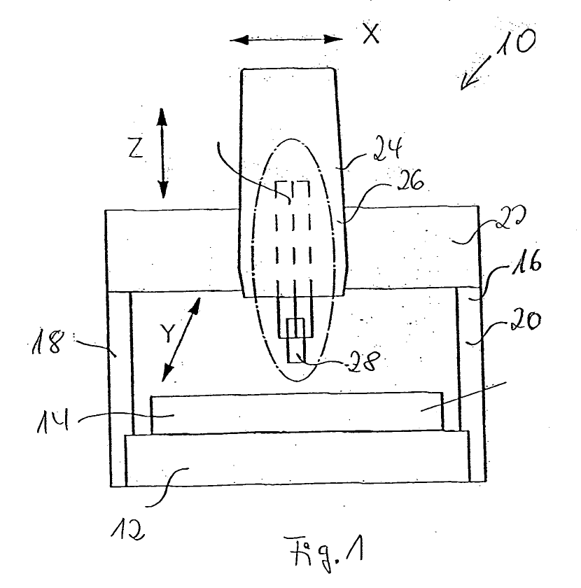

FIG. 1 a principal representation of a coordinate measuring device

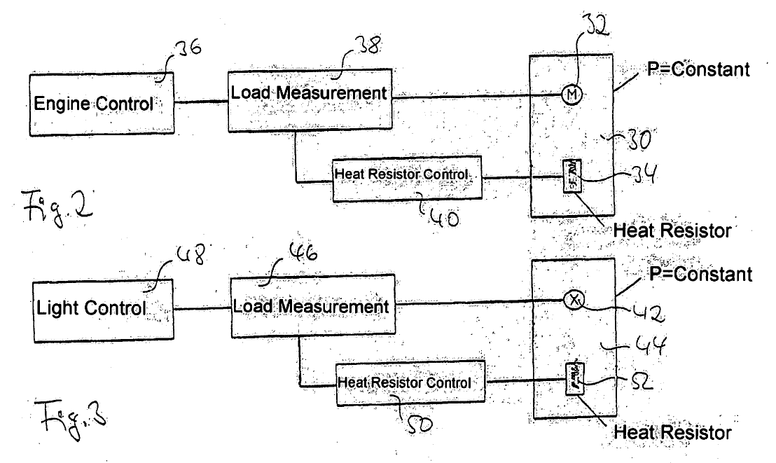

FIG. 2 a principal representation of an engine allocated to the coordinate measuring device and

FIG. 3 a principal representation of an illumination allocated to a coordinate measuring device.

FIG. 1 is purely in principle a coordinate measuring device 10 with for example a basic frame 12, made for example of granite, with a plane table 14 that can be allocated to an object (not shown) that is to be measured. A portal 16 is adjustable in the Y direction along the basic frame 12. For this the columns or pillars 18, 20 are supported in a gliding fashion on the basic frame 12. A traverse 22 extends from the columns 18, 20 along which—in the X direction—a carriage 24 is adjustable, which in turn is equipped with a center sleeve or column 26 that is adjustable in the Z direction. A measurement sensor 28 extends from the center sleeve or column 26 and can have a customary construction like tactile or opto-tactile functioning image processing sensors or as laser distance sensors. To this extent, however, reference is made to sufficiently known technologies and constructions.

In order to ensure that the coordinate measuring device 10 remains thermally stable, meaning that the coordinate measuring device 10 is operated in an environment in which a constant temperature prevails, independent of the heat-emitting components, such as illuminations, engines or similar devices, it is provided according to the invention that a supplementary heat source is allocated to each heat-emitting element so that the heat load that acts upon the coordinate measuring device remains constant.

The realization of the measures to be taken is shown in a purely principal form in FIG. 2 and 3. According to FIG. 2 the load of an electric motor 32 used in a coordinate measuring device 30 is measured, in order to regulate the supplementary heat source such as a heat resistor 34 in such a way, dependent upon the load acceptance or load emission, that the heat load of the coordinate measuring device 30 remains constant. A load measurement 38 is implemented by an engine control 36, in order to use this to regulate the heat resistor 34 via a heat resistor control.

If, according to FIG. 3, in a light source 42 that is allocated to a coordinate measuring device 44, a constant heat effect is to be achieved on the coordinate measuring device 44, then a load measurement 46 of the light control 48 takes place in order to regulate a heat resistor 52 via the heat resistor control 50 in such a way that the heat load of the coordinate measuring device 44 also remains constant.

The measures according to the invention guarantee that the coordinate measuring device 10, 30, 44 is thermally stable, with the consequence that no temperature changes take place for the coordinate measuring device 10, 30, 44 through technically dependent heat sources, preventing measurement corruptions or measurement inaccuracies.

1. Coordinate measuring device (10, 30, 44) with at least one heat-emitting element (32, 42) allocated to it or integrated with it, such as an engine or a light source, characterized in that a supplementary heat source (34, 52) is allocated to the heat-emitting element (32, 42) in such a way that the total load acting upon the coordinate measuring device (10, 30, 42) remains constant or nearly constant.

2. Coordinate measuring device according to claim 1, characterized in that the supplementary heat source is a heat resistor (34, 52).

3. Coordinate measuring device according to claim 1 or 2, characterized in that the supplementary heat source (34, 52) is allocated to the heat-emitting element (32, 42) in such a way that the coordinate measuring device (10, 30, 44) has a constant or nearly constant temperature independent of the load of the heat emitted by the element.

4. Coordinate measuring device according to at least one of the preceding claims, characterized in that the coordinate measuring device (30) is equipped with at least one drive motor (32) that can be operated alternatively with a heat load resistor (34) such that the resulting heat load remains constant.

5. Coordinate measuring device according to at least one of the preceding claims, characterized in that the coordinate measuring device is equipped with an illumination device (42) that can be alternatively controlled in one or several heat load resistors (52) in such a way that the resulting heat load of the coordinate measuring device (44) remains constant.

6. Process for the operation of a coordinate measuring device (10, 30, 44) with at least one heat-emitting element (32, 42) that is allocated to it and/or integrated with it, such as an engine or a light source, characterized in that at least one supplementary light source (34, 52) is allocated to the heat-emitting element (32, 42) in such a way that the total load acting upon the operating coordinate measuring device (10, 30, 44) remains constant or nearly constant.

7. Process according to claim 6, characterized in that the load P₁ received or emitted from the heat-emitting element (32, 42) is measured, and that the supplementary heat source (34, 42) is operated with a load P₂, wherein P₁+P₂=constant or P₁+P₂≈constant.

8. Process according to claim 5 or 6, characterized in that a heat resistor (34, 52) is controlled as the supplementary heat source via the measured load L₁.

9. Process according to at least one of the preceding claims, characterized in that an adjustable heat resistor (34, 52) is allocated to each heat-emitting element (32, 42) in such a way that the load P₁ of the heat-emitting element and the load P₂ of the adjustable heat resistor is P₁+P₂=constant or P₁+P₂≈constant.

10. Process according to at least one of the preceding claims, characterized in that a common adjustable heat resistor is allocated to several heat-emitting elements (32, 42).

11. Process according to at least one of the preceding claims, characterized in that the supplementary heat source(s) (34, 52) is (are) allocated to the coordinate measuring device in such a way that it shows a constant or nearly constant temperature in its measurement influencing area, independent of the effective load or the heat.

12. Process according to at least one of the preceding claims, characterized in that one or more engines (32) of the coordinate measuring device (30) are operated alternatively with heat resistors (34) in such a way that the resulting heat load is constant.

13. Process according to at least one of the preceding claims, characterized in that the bulbs of an illumination device (42) of the coordinate measuring device are operated alternatively with heat resistors, or are regulated with one another, in such a way that the resulting heat load is constant or almost constant for the coordinate measuring device.
